(19) United States
(12) Patent Application Publication
(10) Pub. No.: US 2005/0207089 A1
(43) Pub. Date: Sep. 22, 2005

(54) Substrate holder and exposure apparatus using same

(75) Inventor: Atsushi Ito, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/074,665

(22) Filed: Mar. 9, 2005

(30) Foreign Application Priority Data
Mar. 18, 2004 (JP) 2004-078592

(51) Int. Cl. G03B 27/58

(52) U.S. Cl. 361/234

(57) ABSTRACT

A substrate holder for holding a substrate includes a holding-surface for holding the substrate, a first depression provided around the holding-surface, and a second depression provided around the first depression. The depth of the second depression is smaller than the depth of the first depression.

### BACKGROUND OF THE INVENTION

1. Field of the Invention

The present invention relates to a substrate holder, and more specifically relates to a substrate holder that holds a wafer in an exposure apparatus.

2. Description of the Related Art

Exposure apparatuses expose a substrate to transfer a pattern of a mask to the substrate, and have a substrate holder (chuck) for holding a substrate or a mask. Examples of substrate holders (chucks) include a mechanical chuck, a vacuum chuck, and an electrostatic chuck. The mechanical chuck holds a substrate with a mechanical holding device. The vacuum chuck attracts a substrate by a vacuum between the substrate and the chuck. The electrostatic chuck attracts a substrate by electrostatic force.

With the improvement in density and miniaturization of semiconductor devices, substrate holders are required to hold a substrate with increased accuracy. In order to hold a substrate with higher accuracy, substrate holders need to prevent deformation of the substrate due to thermal expansion caused by exposure to the light, and to prevent deformation of the substrate due to interposition of dust between the substrate and the holding-surface. In addition, the substrate holders need to straighten the substrate. The reason is, in the exposure process, a resist is applied to the surface of the semiconductor wafer, and the wafer is warped in a concave or convex manner.

FIG. 8 shows a typical electrostatic chuck, which is described in, for example, Japanese Patent Laid-Open Nos. 2002-217180 and 2001-110883. In the chucks of these documents, heat-transferring gas or cooling gas is introduced under the substrate so as to remove the heat of the substrate. The chuck of Japanese Patent Laid-Open No. 2002-217180 is provided with a plurality of small raised holding-surfaces and a raised ring-shaped holding-surface on the rim.

However, if the rim of the substrate is held with such a ring-shaped holding-surface, the contact area is large, and therefore the possibility of dust being interposed between the rim of the substrate and the ring-shaped holding-surface increases. Consequently, it is difficult to hold the overall surface of the substrate with a higher accuracy. In addition, there is a possibility that the resist is applied to not only the surface of the wafer but also to the rim of the underside. Therefore, if the rim of the substrate is held with a ring-shaped holding-surface, in addition to the dust, the resist can be interposed between the rim of the substrate and the ring-shaped holding-surface.

Without the ring-shaped holding-surface, since contact area is small, the resist and the dust could be prevented from being interposed. However, in the case where the above-described heat-transferring gas is used in a non-air atmosphere (for example, a vacuum atmosphere), a structure to prevent the leakage of the heat-transferring gas is necessary.

### SUMMARY OF THE INVENTION

The present invention provides a substrate holder for holding a substrate in a non-air atmosphere. In the substrate holder, deformation of the substrate is restricted, and leakage of gas into the non-air atmosphere is reduced.

In accordance with one aspect of the invention, a substrate holder for holding a substrate in a non-air atmosphere includes a holding portion, a plurality of pins extending from the holding portion, with each of the pins having a height and provided with a holding surface for supporting the substrate, and a supplying portion in the holding portion for supplying gas. In addition, a sealing portion seals the gas, with the sealing portion disposed at a periphery of the holding portion and having a depth that is different than the height of the pins.

In accordance with another aspect of the invention, a substrate holder for holding a substrate in a non-air atmosphere includes a holding member having a holding surface for supporting the substrate, and a supplying portion within the holding member for supplying gas. The holding member includes a first depression provided within the holding surface and having a first depth, and a second depression provided around the first depression and having a second depth, with the second depth of the second depression being smaller than the first depth of the first depression. The supplying portion supplies the first depression with gas.

In accordance with yet another aspect of the invention, a substrate holder for use in a vacuum atmosphere includes a holding portion having a holding surface, a first depression of a first depth formed in the holding surface, and a second depression of a second depth formed in the holding surface. The second depression encircles the first depression and has a second depth that is less than the first depth. In addition, a plurality of supports extend from the first and second depressions and form the holding surface, and a gas supplying portion provided in the holding member supplies gas to the first depression.

The gas is used for controlling the temperature of the substrate, which can be held by electrostatic force. The conductance of the sealing portion is 2.0 E-07 m³/s or less. This substrate holder is used, for example, for holding a substrate in an exposure apparatus.

Further features and advantages of the present invention will become apparent from the following description of exemplary embodiments (with reference to the attached drawings).

### BRIEF DESCRIPTION OF THE DRAWINGS

FIG. 1 shows a top plan view and a cross-sectional view of a substrate holder according to a first embodiment.

FIG. 2 shows the conductance of a depression and the degree of vacuum of a vacuum chamber.

FIG. 3 shows a top plan view and a cross-sectional view of a substrate holder according to a second embodiment.

FIG. 4 shows a top plan view and a cross-sectional view of a substrate holder according to a third embodiment.

FIG. 5 shows an EUV exposure apparatus according to a fourth embodiment.

FIG. 6 shows a method for manufacturing semiconductor devices according to a fifth embodiment.

FIG. 7 shows a wafer process according to the fifth embodiment.

FIG. 8 shows a conventional substrate holder.

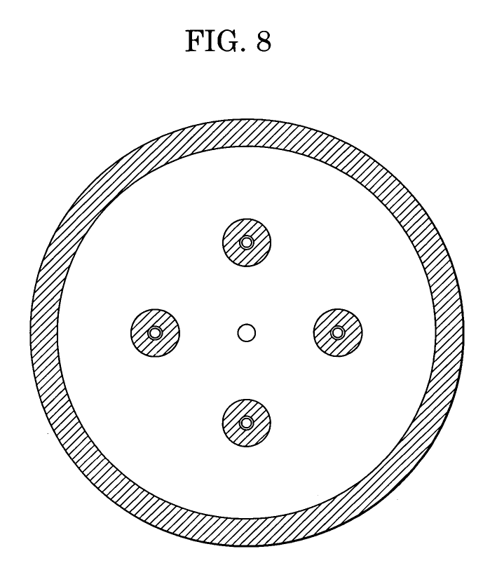

### DESCRIPTION OF THE EMBODIMENTS

### First Embodiment

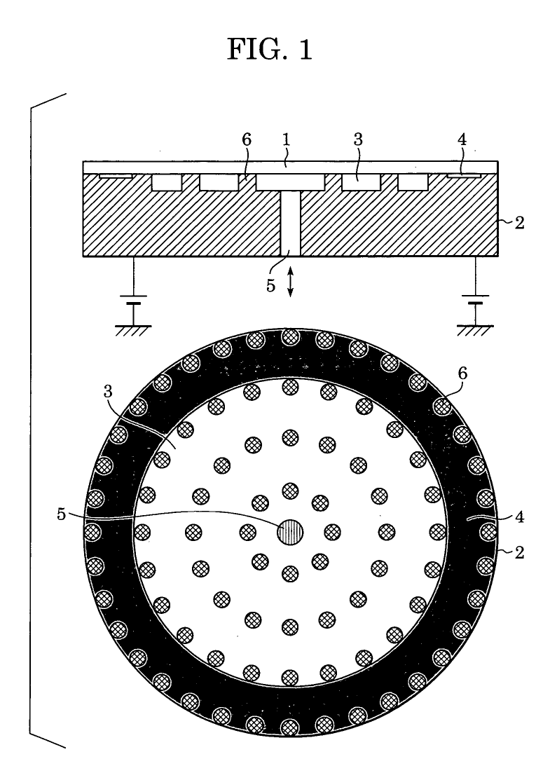

FIG. 1 shows a substrate holder according to a first embodiment. A substrate 1 is held by a holding portion (chuck) 2 in a vacuum chamber. In FIG. 1, the holding portion 2 is provided with a plurality of pins 6, and the substrate 1 is held by tips of the pins 6. A first depression 3 and a second depression 4 are provided between the pins 6. The first depression 3 is provided with a port 5 for supplying gas. The heat-transferring gas supplied from the port 5 fills the first depression 3 so as to allow the accumulated heat to escape from the substrate 1. The substrate 1 can be maintained at a desired temperature by adjusting the temperature of the heat-transferring gas.

The second depression 4 is provided on the rim of the substrate 1. The second depression 4 is shallower than the first depression 3 so as to restrict the gas from leaking into the vacuum chamber.

This is based on the idea that if the gas leaks through a leaking path into the vacuum chamber, the degree of vacuum in the vacuum chamber can be maintained at a desired degree by controlling the conductance of the leaking path. The term “leaking path” here means the second depression 4. Therefore, a desired degree of vacuum can be obtained by adjusting the conductance of the second depression 4.

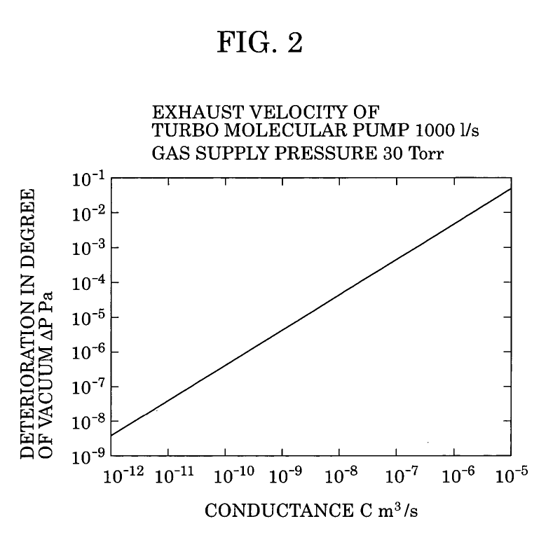

FIG. 2 shows the relation between the conductance of the leaking path and the deterioration in the degree of vacuum in the vacuum chamber. Since the supply pressure of the heat-transferring gas is tens of Torr, the gas pressure just before the leaking path is assumed to be 30 Torr. In this case, the vacuum chamber is exhausted with a commonly used turbo molecular pump at an exhaust velocity of 1000 l/s. In order to maintain the vacuum chamber at a desired degree of vacuum, the conductance of the leaking path is determined according to FIG. 2. For example, in order to maintain the deterioration in the degree of vacuum at E-04 Pa level, the conductance of the leaking path needs to be at 2.0 E-07 m³/s or less.

The case where the target degree of vacuum of the vacuum chamber is at E-04 Pa level and the second depression 4 has a uniform depth will be described. When the substrate 1 is assumed to be a 12-inch wafer, and heat-transferring gas is supplied, the width of the second depression 4 is limited to 20 mm in consideration of exposure area. When the width of the second depression 4 is 20 mm, in order to restrict the conductance of the second depression 4 to 2.0 E-07 m³/s, the depth of the second depression 4 needs to be 2.3 μm or less. When the width of the second depression 4 is 3 mm, the depth of the second depression 4 needs to be 0.9 μm or less. As long as these conditions are met, when a vacuum pump whose exhaust velocity is 1000 l/s is used, the degree of vacuum in the vacuum chamber can be maintained at E-04 Pa level.

In the case where a vacuum pump whose exhaust velocity is larger than 1000 l/s is used, or in the case where the gas pressure just before the leaking path is lower than 30 Torr, the maximum conductance allowable for maintaining the degree of vacuum at E-04 Pa level is larger than 2.0 E-07 m³/s. If the necessary degree of vacuum is lower than E-04 Pa, the value of conductance may be large. That is to say, the necessary value of conductance varies according to the gas pressure and the pump performance, and it is determined according to the desired degree of vacuum.

Since the rim is also provided with a depression, the contact area between the substrate and the holding-surface decreases. Compared with the ring-shaped holding-surface disclosed in Japanese Patent Laid-Open No. 2002-217180, the possibility that dust is interposed between the substrate and the holding-surface is reduced. In addition, the resist on the underside of the substrate is prevented from being interposed between the substrate and the holding-surface. The shapes of the depressions include all the shapes designed on the basis of the above-described idea.

In consideration of straightening, the depressions are designed so that the overall substrate can be held appropriately. For example, as shown in FIG. 1, a plurality of pins 6 are arranged concentrically. In order to prevent the dust from being interposed, the area of the holding-surface should be minimized as long as the substrate is straightened appropriately. Since the present invention uses an electrostatic chuck in this embodiment, when the depth of the depressions are sufficiently small, not only the pins but also the depressions exert electrostatic attracting force on the substrate.

This structure eliminates the need for providing a ring-shaped holding-surface on the rim, and prevents the dust and the resist from being interposed between the rims of the substrate and the holder. In addition, this structure increases the design flexibility of the holding-surface, thereby making it possible to hold the overall surface of the substrate appropriately.

Although the substrate is held in a vacuum atmosphere in this embodiment, the present invention is not limited to a vacuum atmosphere. The atmosphere has only to be non-air atmosphere. In the case of vacuum atmosphere, the substrate can be held by electrostatic force instead of vacuum attracting force.

The pins 6 may be provided as part of the holding portion 2. Alternatively, the pins 6 may be provided as separate parts from the holding portion 2. The second depression 4 may also be provided as a separate part from the holding portion 2. In this case, the second depression 4 has only to be a member that can seal the gap between the substrate 1 and the holding portion 2 so that the gas does not leak out. It is important that the sealing-surface (the second depression 4) is lower than the holding-surface (the top of the pins 6).

### Second Embodiment

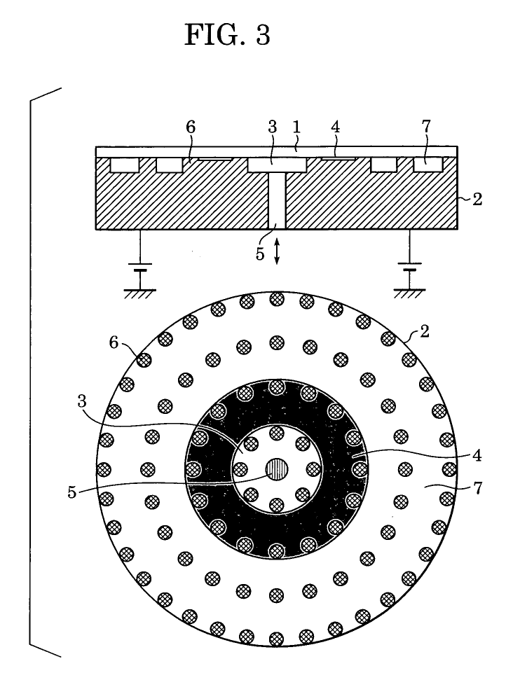

FIG. 3 shows a substrate holder according to a second embodiment. A first depression 3 is filled with the heat-transferring gas. The first depression 3 in this embodiment is smaller than that in the first embodiment. A mask is formed of a material having a relatively low coefficient of linear thermal expansion, and is tolerant of temperature changes. Since the required degree of cooling is small, the overall surface of the mask need not be cooled. A second depression 4 restricts the leakage of the heat-transferring gas. The depth and length of the second depression 4 determine the conductance. In this embodiment, since the first depression 3 is small, the depth and length of the second depression 4 can be designed freely.

When the diameter of the first depression 3 is assumed to be 100 mm, and all the rest is assumed to be the second depression 4 (100 mm in width), the depth of the second depression 4 required for maintaining the conductance at 2.0 E-07 m³/s or less is 9 μm or less. The depressions can be designed and formed easily, and consequently the manufacturing cost can be reduced.

As shown in FIG. 3, a third depression 7 is provided around the second depression 4. In this embodiment, the third depression 7 is as deep as the first depression 3. However, the depth of the third depression 7 may be determined freely as long as the dust is prevented from being interposed between the substrate 1 and the third depression 7.

### Third Embodiment

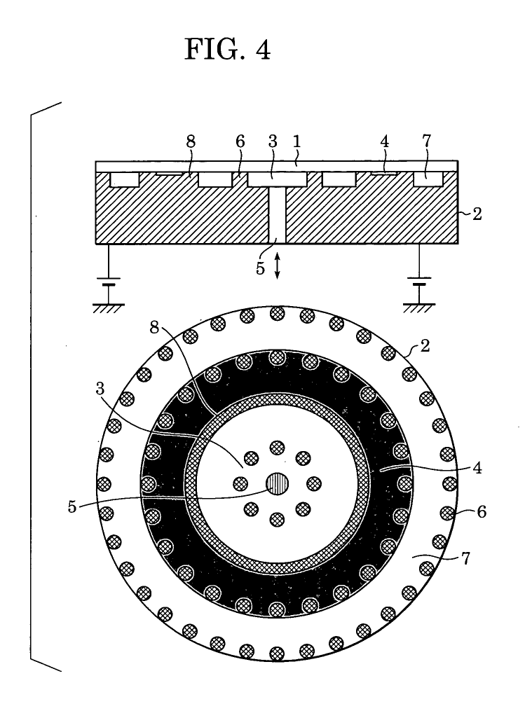

FIG. 4 shows a substrate holder according to a third embodiment. This embodiment achieves a higher sealing performance. In this embodiment, a ring-shaped holding-surface 8 is provided around a first depression 3 so as to seal the heat-transferring gas, and a second depression 4 is provided around the ring-shaped holding-surface 8. Since the ring-shaped holding-surface 8 is not located on the rim, the resist on the rim on the underside of the wafer is not interposed between the wafer and the ring-shaped holding-surface 8. However, in order to prevent the dust from being interposed, the area of the ring-shaped holding-surface 8 should be minimized as long as the substrate is straightened appropriately.

### Fourth Embodiment

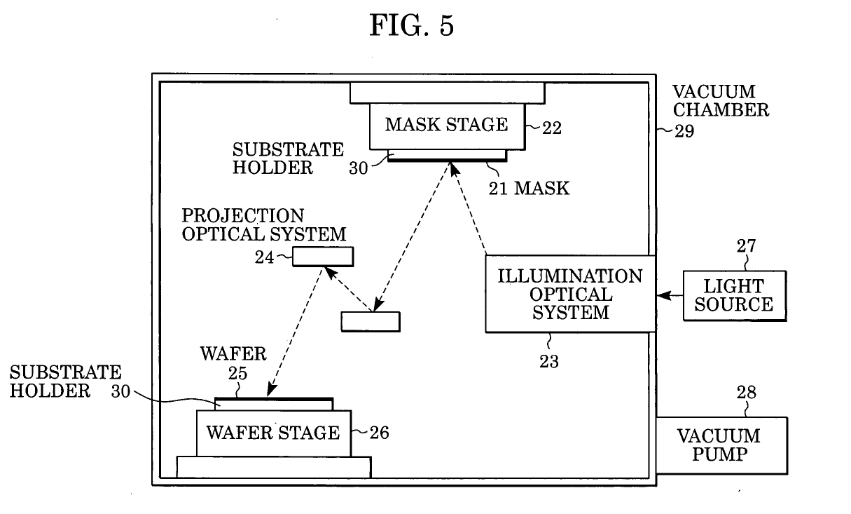

A fourth embodiment is an exposure apparatus including the substrate holder according to the first, second, or third embodiment. FIG. 5 is a schematic view of an extreme-ultraviolet (EUV) exposure apparatus as an example of an exposure apparatus to which the present invention is applied. A pattern of a mask 21 is transferred to the wafer (substrate) 25 via a projection optical system 24. This exposure apparatus includes a reflective mask 21, a projection optical system 24 composed of a catoptric system, a substrate holder 30 holding the mask 21, a mask stage 22, another substrate holder 30 holding the wafer (substrate) 25, and a wafer stage 26. This exposure apparatus is a step-and-scan type scanning exposure apparatus, and uses EUV light whose oscillation spectrum is 5 to 15 nm (soft X-ray). Since the wavelength of the EUV light is short, if the exposure is performed in the air or nitrogen atmosphere, the exposure light is absorbed by oxygen molecules or nitrogen molecules. Therefore, the exposure needs to be performed in a vacuum chamber 29 with a vacuum pump 28.

EUV exposure apparatuses and electron beam drawing apparatuses form a high-density and microscopic pattern, and therefore need a substrate holder capable of holding a substrate with high accuracy. The substrate holder according to the present invention meets the need.

The exposure apparatus is not limited to an EUV exposure apparatus. The exposure apparatus may use another light source. The exposure apparatus according to the present invention can be applied to not only the above-mentioned step-and-scan type exposure apparatus but also a step-and-repeat type exposure apparatus.

### Fifth Embodiment

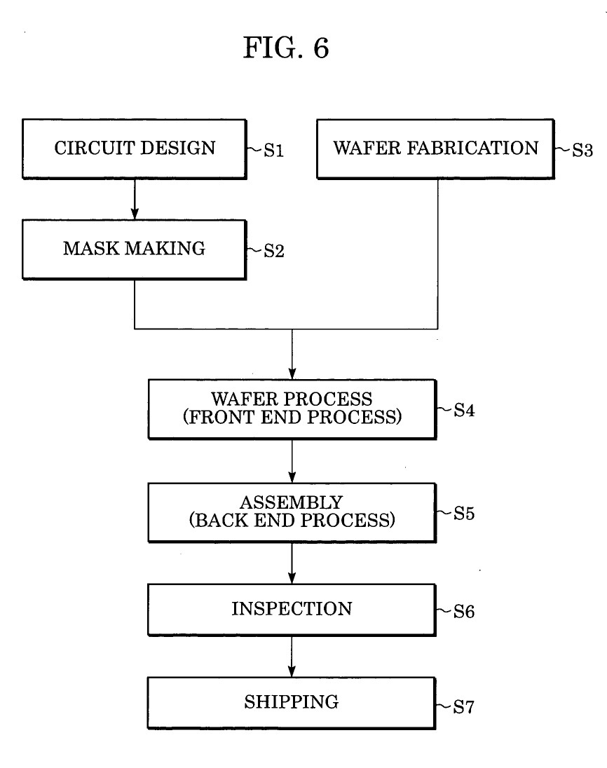

Referring to FIG. 6, a manufacturing process of semiconductor devices will be described. The exposure apparatus according to the fourth embodiment is used in this process. FIG. 6 shows the flow of the whole manufacturing process of semiconductor devices. In step 1 (circuit design), a semiconductor device circuit is designed. In step 2 (mask making), a mask having a designed circuit pattern is formed.

In step 3 (wafer fabrication), a wafer is manufactured using a material such as silicon. Step 4 (wafer process) is called a front end process. In step 4, an actual circuit is formed on the wafer by lithography using the above exposure apparatus. Step 5 (assembly) is called a back end process. In step 5, a semiconductor chip is made of the wafer manufactured in step 4. Step 5 includes an assembly process (dicing and bonding) and a packaging process (chip encapsulation). In step 6 (inspection), inspections such as an operation confirmation test and a durability test of the semiconductor device manufactured in step 5 are conducted. After these steps, the semiconductor device is completed and shipped in step 7.

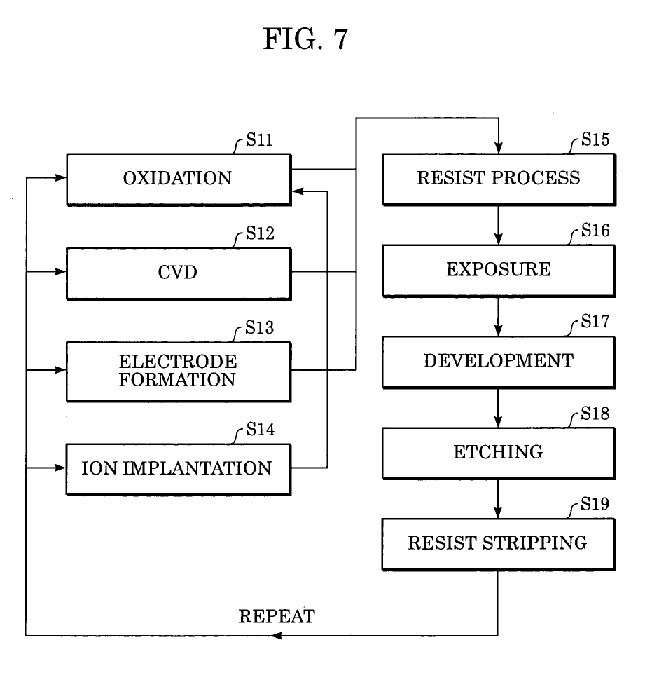

FIG. 7 shows the detailed flow of the wafer process in step 4. In step 11 (oxidation), the surface of the wafer is oxidized. In step 12 (CVD), an insulating film is formed on the wafer surface. In step 13 (electrode formation), electrodes are formed on the wafer by vapor deposition. In step 14 (ion implantation), ions are implanted in the wafer. In step 15 (resist process), a photosensitive material is applied to the wafer. In step 16 (exposure), the circuit pattern is transferred to the wafer with the above exposure apparatus. In step 17 (development), the exposed wafer is developed. In step 18 (etching), the wafer is etched except for the developed resist image. In step 19 (resist stripping), the resist is removed. These steps are repeated, and multilayer circuit patterns are formed on the wafer.

Since the manufacturing process according to the fifth embodiment includes a step of exposing the substrate by using the exposure apparatus according to the fourth embodiment, high-density and miniaturized devices can be manufactured.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-078592 filed Mar. 18, 2004, which is hereby incorporated by reference herein.

1. A substrate holder for holding a substrate in a non-air atmosphere, the holder comprising:
a holding portion;
a plurality of pins extending from the holding portion, each of the plurality of pins having a height and provided with a holding-surface for supporting the substrate;
a supplying portion in the holding portion for supplying gas; and
a sealing portion for sealing the gas, the sealing portion being disposed at a periphery of said holding portion and having depth that is different than the height of the pins.

2. The substrate holder according to claim 1, wherein the gas is used for controlling the temperature of the substrate.

3. The substrate holder according to claim 1, wherein the substrate is held by electrostatic force.

4. The substrate holder according to claim 1, wherein a conductance of the sealing portion is 2.0 E-07 m³/s or less.

5. An exposure apparatus holding a substrate with the substrate holder according to claim 1.

6. A substrate holder for holding a substrate in a non-air atmosphere, the holder comprising:
(a) a holding member having a holding-surface for supporting the substrate, the holding member comprising:
(1) a first depression provided within the holding-surface and having a first depth; and
(2) a second depression provided around the first depression and having a second depth, with the depth of the second depression being smaller than the first depth of the first depression, and
(b) a supplying portion within the holding member for supplying the first depression with gas.

7. The substrate holder according to claim 6, wherein the gas is used for controlling the temperature of the substrate.

8. The substrate holder according to claim 6, wherein the substrate is held by electrostatic force.

9. The substrate holder according to claim 6, wherein the holding member further comprises:
(3) a third depression provided around the second depression.

10. The substrate holder according to claim 6, wherein a conductance of the second depression is 2.0 E-07 m³/s or less.

11. The substrate holder according to claim 6, wherein the depth of the second depression is 10 μm or less.

12. An exposure apparatus holding a substrate with the substrate holder according to claim 6.

13. A substrate holder for use in a vacuum atmosphere, comprising:
a holding member having a holding surface;
a first depression of a first depth formed in the holding surface;
a second depression of a second depth formed in the holding surface, the second depression encircling the first depression and the second depth being less than the first depth;
a plurality of supports extending from the first and second depressions and forming the holding surface; and
a gas supplying portion in the holding member for supplying gas to the first depression.

14. A substrate holder according to claim 13, further comprising a third depression formed in the holding surface and encircling the second depression.

15. A substrate holder according to claim 14, wherein the third depression has a depth greater than the depth of the second depression.

16. A substrate holder according to claim 14, wherein the third depression has a depth substantially equal to the depth of the first depression.

17. A substrate holder according to claim 14, further comprising a concentric ring disposed between the first and second depressions.
